(19) United States
(12) Patent Application Publication
(10) Pub. No.: US 2006/0017238 A1
(43) Pub. Date: Jan. 26, 2006

(54) Collet system for use in lens production

(76) Inventors: Konrad Bergandy, Germantown, MD (US); Wieslaw Bergandy, Upper Marlboro, MD (US)

Correspondence Address: MINTZ LEVIN COHN FERRIS GLOVSKY AND POPEO PC, 12010 SUNSET HILLS ROAD, SUITE 900, RESTON, VA, 20190, US

(21) Appl. No.: 10/896,231

(22) Filed: Jul. 22, 2004

(51) Int. Cl. B23B 31/20

(52) U.S. Cl. 279/51

(57) ABSTRACT

A collet system holds a work-piece for processing by a machine. The collet system may retain the work-piece while engaging a cone associated with the machine. The collet system may include a collet body that forms a work-piece opening for retaining the work-piece with a substantially fixed compression independent of a draw down tension exerted by a drawing component associated with the machine on the collet system. Retaining the work-piece with a substantially fixed compression may enhance various aspects of holding the work-piece. For example, the compression provided to the work-piece may be predictable, crimping of the work-piece due at least in part to over-compressing the work-piece may be reduced, work-piece slippage due at least in part to under-compressing the work-piece may be reduced, or other aspects may be enhanced.

### FIELD OF THE INVENTION

The invention is a collet system that holds a work-piece for processing by a machine during lens production.

### BACKGROUND OF THE INVENTION

In lens production, particularly contact lens production, a work-piece, sometimes referred to as a button, may be retained in a collet system. The collet system may be secured in a cone, such as a chuck or other cone, associated with a machine, such as a lathe, a mill, or another machine, for processing. The collet system may retain the work-piece by applying a compressive force to the work-piece. In some systems, the compressive tension (or other appropriate force) may be increased or decreased by applying a greater or smaller draw down tension to the collet system. The draw down tension may be applied to the collet system by a drawing component associated with the machine, such as a draw down bar or other drawing component with conventional collet systems.

Applying the draw down tension to determine a compressive force to retain a work-piece may introduce errors in the application of compressive force to the work-piece. For example, a draw down tension may not be large enough, in which case, the work-piece may not be securely retained, or a draw down tension may be too large, in which case, the work-piece may be over-compressed and “collet crimping” of the work-piece may be induced.

In typical lens production, the size (e.g., a radius, etc.) of one work-piece to be retained by a collet system may vary slightly from the size of another work-piece to be retained by the same collet system. This may frustrate efforts to apply an appropriate and/or consistent compressive force to retain the work-piece by adjusting the draw down tension.

Therefore, what is needed is a collet system that may retain a work-piece with a configurable fixed (or substantially fixed) compressive force, independent of the size of the work-piece and/or the draw down tension induced in the collet system by the drawing portion.

### SUMMARY OF THE INVENTION

One aspect of the invention may relate to a collet system that holds a work-piece for processing by a machine. The collet system may retain the work-piece while engaging a cone associated with the machine. A cone may include a chuck. The collet system may include a collet body in which is formed a work-piece opening for retaining the work-piece with a substantially fixed compression independent of a draw down tension exerted by a drawing component associated with the machine on the collet system. The work-piece opening may also retain the work-piece independent of minor variations in button radius. For example, the drawing component may include a draw down bar.

Retaining the work-piece with a substantially fixed compression may enhance various aspects of holding the work-piece. For example, the compression provided to the work-piece may be predictable, crimping of the work-piece due at least in part to over-compressing the work-piece may be reduced, work-piece slippage due at least in part to under-compressing the work-piece may be reduced, or other aspects may be enhanced.

In some embodiments of the invention, the collet system may be a “dead length system.” A dead length system may hold the work-piece in a substantially fixed position with respect to the cone independent of the size of the work-piece and/or a draw down tension. In other words, any minor deviations in the sizes among work-pieces does not affect the position of the work-piece in relation to the cone. Similarly, a draw down tension may be changed without effecting work-piece positioning.

In some embodiments of the invention, the collet system may include a support member. The support member may include a plurality of supports. The supports may engage the cone circumferentially to the collet system. The collet system may include a tension member. The tension member may include a drawing portion. The drawing portion may be engaged by the drawing component to draw down the collet system with a draw down tension. The collet system may include a collet body. The collet body may include a collet rim. The collet rim may form a work-piece opening. The surfaces of the collet rim that form the work-piece opening may compressively retain a work-piece with a substantially fixed compression independent of the draw down tension.

According to various embodiments of the invention, the surfaces of the supports of the support member that engage the cone may be curved in a lengthwise direction with respect to the collet system. The profiles of the surfaces of the supports that may engage the cone may follow a parabolic curve, an arc, or another curve. Curving the surfaces of the supports that engage the cone in a lengthwise direction with respect to the collet system may reduce seating errors between the collet system and the cone, or provide other advantages. For example, seating errors may include engaging the cone such that the collet system is seated at an angle with respect to the cone, engaging the cone such that the collet system is seated at an offset with respect to the cone, or other seating errors.

In some embodiments of the invention, the support member may include a work-piece seating portion. The work-piece seating portion may include a work-piece seating surface. The work-piece may rest against the work-piece seating surface as the work-piece is retained by the collet system.

According to various embodiments of the invention, the support member may include a support member retaining portion. The support member retaining portion may include a support member retaining surface. At the support member retaining surface, a support retaining force may be applied to the support member. The support retaining force may cause the supports to engage the cone.

In some embodiments of the invention, the collet system may include a support retaining force component. The support retaining force component may provide the support retaining force to the support member. The support retaining force component may include a spring. The support retaining force component may compressed to provide the support retaining force to the support member.

According to various embodiments of the invention, the support retaining force component may be compressed by the tension member. The tension member may be provided inside of the support member and/or the support retaining force component.

In some embodiments, the drawing portion of the tension member may include a tensioning mechanism. The tensioning mechanism may provide the draw down tension to the tension member. For example, the tensioning mechanism may include a set of male threads, a set of female threads, or other mechanisms.

According to various embodiments of the invention, the tension member may include a tension member head. The tension member head may be located at the opposite end of the tension member from the drawing section. The tension member head may include a draw down tension control, such as a torquing interface, or other tension control. A torquing interface may include an interface for a Phillips head screw driver, an interface for a flat-head screw driver, an interface for an Allen hex wrench, an interface for a star wrench, or other interfaces.

In some embodiments of the invention, the tension member head may include a retaining surface. The retaining surface may provide a retaining force created at least in part by the draw down tension. The retaining surface may provide at least a portion of the retaining force to the support retaining force component to compress the support retaining force component. Compressing the support retaining force component may enable the support retaining force component to provide the support retaining force to the support member.

According to various embodiments of the invention, the collet system may include a collet body retaining force component. The collet body retaining force component may receive at least a portion of the retaining force from the retaining surface of the tension member head. The retaining force may compress the collet body retaining force component. Compressing the collet body retaining force component may enable the collet body retaining force component to provide a collet body retaining force to the collet body. The collet body retaining force component may include a spring.

In some embodiments of the invention, the collet body may form a collet body bore and a plurality of collet body slots. The collet body bore and the collet body slots may enable the collet body to be disposed around the tension member and the support member.

According to various embodiments of the invention, the collet body may include a collet body retaining surface. The collet body retaining surface may receive the collet body retaining force provided by the collet body retaining force component. The collet body retaining force may hold the collet body in position with respect to the cone.

In some embodiments of the invention, the size of the work-piece opening formed by the collet rim of the collet body may be configurable. For example, the size of the work-piece opening may be configurable by manipulating various aspects of the collet body retaining force component, such as, a spring constant, a size, or other aspects. Configuring the size of the work-piece opening may enhance various aspects of retaining the work-piece, such as enabling the compression used to retain the work-piece to be configured, enabling the work-piece opening to accommodate minor variations in the size of the work-pieces, or other aspects.

According to various embodiments of the invention, the surfaces of the collet rim that retain the work-piece may be textured. The surfaces of the collet rim that retain the work-piece may be textured to enhance one or more aspects of the interface between the collet system and the work-piece, such as a friction, or other aspects. The texture may be provided by one or more impregnations of a foreign material, such as carbide, or other materials. Alternatively, the texture may be provided to the surfaces of the collet rim that retain the work-piece by an alternative texturing method, such as coating, grinding, knurling, surfacing, or other texturing methods.

In some embodiments of the invention, one or more outer rim surfaces formed on the outer side of the collet rim may be curved in a lengthwise direction with respect to the collet system. The profiles of the outer rim surfaces in a lengthwise direction with respect to the collet system may follow a parabolic curve, an arc, or another curve. Curving the outer rim surfaces in a length wise direction with respect to the collet system may reduce seating errors between the collet system and the cone, or provide other advantages. For example, seating errors may include engaging the cone such that the collet system is seated at an angle with respect to the cone, engaging the cone such that the collet system is seated at an offset with respect to the cone, or other errors.

According to various embodiments of the invention, when the collet system is assembled, a protruding portion of the tension member may protrude past an insertion end of the collet body. The protruding portion may be adapted to accept an auxiliary member. The auxiliary member may hold or retain the collet system together when the collet system is disengaged from the cone. For example, the auxiliary member may include a snap ring, retaining clip, or other members.

### BRIEF DESCRIPTION OF THE DRAWINGS

FIG. 1 illustrates a perspective view of an assembled collet system.

FIG. 2 illustrates a perspective view of an exploded collet system.

FIG. 3 illustrates an elevation view of a cross section of an assembled collet system.

### DETAILED DESCRIPTION OF THE DRAWINGS

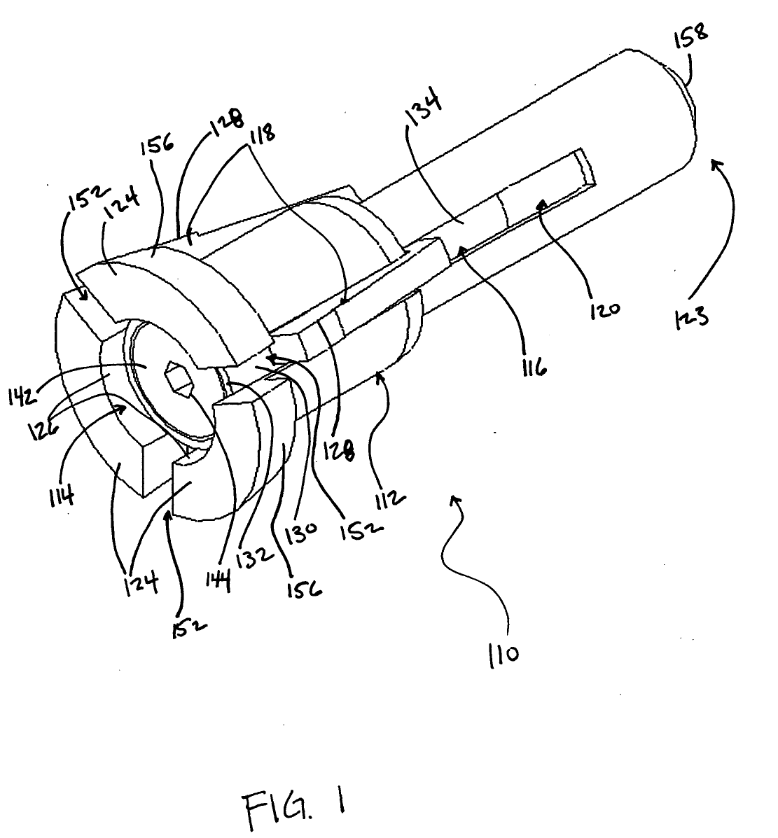

FIGS. 1-3 illustrate an exemplary embodiment of a collet system 110 that holds a work-piece for processing by a machine. Collet system 110 may retain the work-piece while engaging a cone associated with the machine. Collet system 110 may include a collet body 112 that forms a work-piece opening 114 for retaining the work-piece with a substantially fixed compression independent of a draw down tension exerted by a drawing component associated with the machine on collet system 110. Retaining the work-piece with a substantially fixed compression may enhance various aspects of holding the work-piece. For example, the compression provided to the work-piece may be predictable, crimping of the work-piece due at least in part to over-compressing the work-piece may be reduced, work-piece slippage due at least in part to under-compressing the work-piece may be reduced, or other aspects may be enhanced.

In some embodiments of the invention, collet system 110 may be a dead length system. A dead length system may hold the work-piece in a substantially fixed position with respect to the cone independent of the size of the work-piece and/or a draw down tension. In other words, minor variations or deviations in size between work pieces does not change the position of the work-piece in relation to the cone. Similarly, a draw down tension may vary or be changed without effecting work-piece positioning.

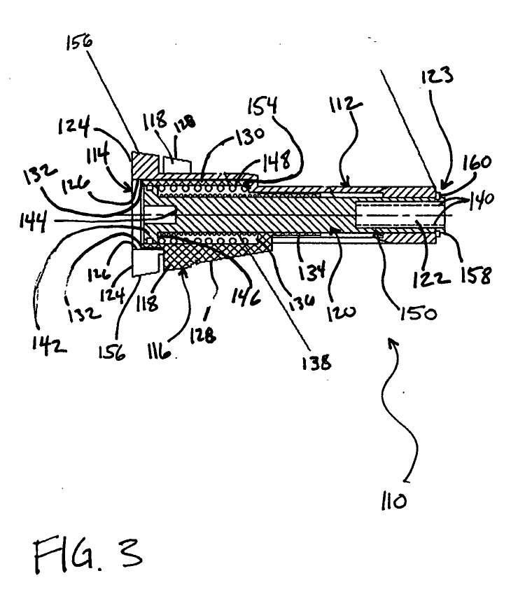

In some embodiments of the invention, collet system 110 may include a support member 116. Support member 116 may include a plurality of supports 118. Supports 118 may engage the cone circumferentially to collet system 110. Collet system 110 may include a tension member 120. Tension member 120 may include a drawing portion 122, as illustrated in FIG. 3. Drawing portion 122 may be engaged by the drawing component to draw down collet system 110 with a draw down tension. Drawing portion 122 may be located at an insertion end 123 of collet system 110 to be inserted into the cone. Collet body 112 may include a collet rim 124. Collet rim 124 may form work-piece opening 114. One or more surfaces 126 of collet rim 124 that form work-piece opening 114 may compressively retain a work-piece with a substantially fixed compression independent of the draw down tension.

According to various embodiments of the invention, one or more support surfaces 128 of supports 118 of support member 116 that engage the cone may be curved in a lengthwise direction with respect to collet system 110. The profiles of support surfaces 128 may follow a parabolic curve, an arc, or another curve. Curving support surfaces 128 in a lengthwise direction with respect to collet system 110 may reduce seating errors between collet system 110 and the cone, or provide other advantages. For example, seating errors may include engaging the cone such that collet system 110 is seated at an angle with respect to the cone, engaging the cone such that collet system 110 is seated at an offset with respect to the cone, or other seating errors.

In some embodiments of the invention, support member 116 may include a work-piece seating portion 130. Work-piece seating portion 130 may include a work-piece seating surface 132. The work-piece may rest against work-piece seating surface 132 as the work-piece is retained by collet system 110.

According to various embodiments of the invention, support member 116 may include a support member retaining portion 134. Support member retaining portion 134 may include a support member retaining surface 136. At support member retaining surface 136, a support retaining force may be applied to support member 116. The support retaining force may cause supports 118 to engage the cone.

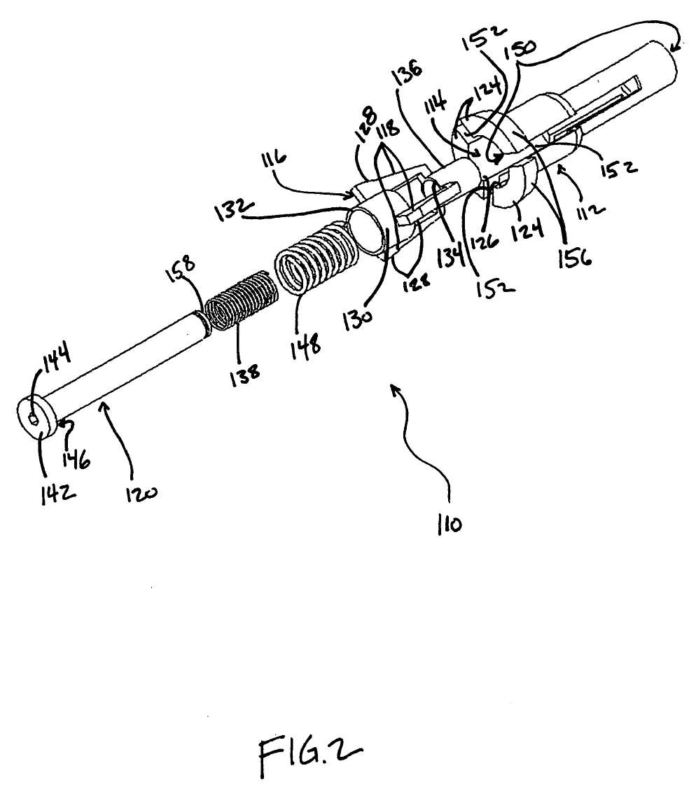

In some embodiments of the invention, collet system 110 may include a support retaining force component 138, as illustrated in FIGS. 2 and 3. Support retaining force component 138 may provide the support retaining force to support member 116. Support retaining force component 138 may include a spring or other device as would be apparent. Support retaining force component 138 may be compressed to provide the support retaining force to support member 116.

According to various embodiments of the invention, support retaining force component 138 may be compressed by tension member 120. Tension member 120 may be provided inside of support member 116 and/or support retaining force component 138, as illustrated in FIG. 3.

In some embodiments, drawing portion 122 of tension member 120 may include a tensioning mechanism 140. FIG. 3 illustrates an exemplary embodiment of tensioning mechanism 140, which may provide the draw down tension to tension member 120. For example, tensioning mechanism 140 may include a set of male threads, a set of female threads, or other mechanisms.

According to various embodiments of the invention, tension member 120 may include a tension member head 142. Tension member head 142 may be located at an end of collet system 110 opposite from insertion end 123. Tension member head 142 may include a draw down tension control 144, such as a torquing interface formed therein, or other tension control. For example, a torquing interface formed therein may include an interface for a Phillips head screw driver, an interface for a flat-head screw driver, an interface for an Allen hex wrench, an interface for a star wrench, or other interfaces.

FIG. 3 illustrates an embodiment of tension member head 142 that may include a retaining surface 146. Retaining surface 146 may provide a retaining force created at least in part by the draw down tension. Retaining surface 146 may provide at least a portion of the retaining force to support retaining force component 138. This may induce a compression in support retaining force component 138 between retaining surface 146 and support member retaining surface 136. Compressing support retaining force component 138 between retaining surface 146 and support member retaining surface 136 by applying at least a portion of the retaining force at retaining surface 146 may enable support retaining force component 138 to provide the support retaining force to support member 116.

FIG. 3 illustrates an exemplary embodiment of collet system 110 that may include a collet body retaining force component 148. Collet body retaining force component 148 may receive at least a portion of the retaining force from retaining surface 146 of tension member head 142. The retaining force may compress collet body retaining force component 148. Compressing collet body retaining force component 148 may enable collet body retaining force component 148 to provide a collet body retaining force to collet body 112. Collet body retaining force component 148 may include a spring or other device as would be apparent.

In some embodiments of the invention, collet body 112 may form a collet body bore 150 running the entire length of collet body 112. Collet body bore 150 may be formed such that support member 116, tension member 120, collet body retaining force component 148, and support retaining force component 138 may be nested therein. Collet body 112 may form a plurality of collet body slots 152. Collet body slots 152 may be formed such that an extrusion of supports 118 out of collet body 112 may be accommodated.

According to various embodiments of the invention, collet body 112 may include a collet body retaining surface 154, as illustrated in FIG. 3. Collet body retaining surface 154 may be positioned such that as the retaining force is applied to collet body retaining force component 148 by retaining surface 146, collet body retaining force component is compressed between collet body retaining surface 154 and retaining surface 146. Compressing collet body retaining force component 148 between collet body retaining surface 154 and retaining surface 146 may apply the collet body retaining force to collet body 112 at collet body retaining surface 154. The collet body retaining force may retain collet body 112 in position with respect to the cone. Since the collet body retaining force may be applied to collet body 112 without engaging collet body 112 with the cone or drawing component directly, collet body 112 may provide a substantially fixed work-piece opening 114 for retaining the work-piece with a substantially fixed compression independent from the draw down tension. The indirect application of the collet body retaining force to collet body 112 via collet body retaining force member 148 may enable collet body 112 to remain at a fixed (or substantially fixed) position with respect to the cone independent from the draw down tension. In other words, a dead length system may be created.

In some embodiments of the invention, the size of work-piece opening 114 formed by collet rim 124 of collet body 112 may be configurable. For example, the size of work-piece opening 114 may be configurable by manipulating various aspects of collet body retaining force component 148, such as, a spring constant, a size, or other aspects. Configuring the size of work-piece opening 114 may enhance various aspects of retaining the work-piece, such as, enabling the compressive force used to retain the work-piece to be configured, enabling work-piece opening 114 to accommodate minor variations in the size of the work-pieces, or other aspects. For example, the size of work-piece opening 114 may be configured according to a configuration variable, such as, a work-piece size, a desired compression to be applied to the work-piece, or another configuration variable.

According to various embodiments of the invention, one or more surfaces 126 of collet rim 124 that retain the work-piece may be textured. Surfaces 126 may be textured to enhance one or more aspects of the interface between collet system 110 and the work-piece, such as a friction, or other aspects. The texture may be provided by one or more impregnations of a foreign material, such as carbide, or other material or mechanism for applying texture to surfaces 126. Alternatively, the texture may be provided to surfaces 126 by an alternative texturing method, such as coating, grinding, knurling, surfacing, or other texturing methods.

In some embodiments of the invention, one or more outer rim surfaces 156 formed on the outer side of collet rim 124 may be curved in a lengthwise direction with respect to collet system 110. The profiles of outer rim surfaces 156 in a lengthwise direction with respect to collet system 110 may follow a parabolic curve, an arc, or another curve. Curving of outer rim surfaces 156 in a lengthwise direction with respect to collet system 110 may reduce seating errors between collet system 110 and the cone, or provide other advantages. For example, seating errors may include engaging the cone such that collet system 110 is seated at an angle with respect to the cone, engaging the cone such that collet system 110 is seated at an offset with respect to the cone, or other errors.

According to various embodiments of the invention, when collet system 110 is assembled, a protruding portion 158 of tension member 120 may protrude from collet body 112 at insertion end 123 of collet system 110. Protruding portion 158 may be adapted to accept an auxiliary member 160. As illustrated in FIG. 3, auxiliary member 160 may hold collet system 110 together when the collet system 110 is disengaged from the cone. For example, auxiliary member 160 may include a snap ring, retaining clip, or other mechanisms for holding collet system 110 together.

What is claimed is:

1. A collet system that holds a work-piece for processing by a machine by retaining the work-piece while engaging a cone associated with the machine and a drawing component associated with the machine, the system comprising:
a plurality of supports that engage the cone circumferentially to the collet system;
a drawing portion that is engaged by the drawing component to draw down the collet system with a draw down tension; and
a collet rim that forms a work-piece opening, the surfaces of the collet rim that form the work-piece opening compressively retaining the work-piece with a substantially fixed compression independent of the draw down tension.

2. The system of claim 1, wherein the collet system is dead length system.

3. The system of claim 1, wherein the surfaces of the collet rim that compressively retain the work-piece are textured to increase friction between the work-piece and the surfaces of the collet rim.

4. The system of claim 4, wherein the surfaces of the collet rim that compressively retain the work-piece are textured with one or more carbide impregnations.

5. The system of claim 1, wherein the profiles of the surfaces of the supports that engage the cone in a lengthwise direction with respect to the collet system are curved.

6. A collet system that holds a work-piece for processing by a machine by retaining the work-piece while engaging a cone associated with the machine and a drawing component associated with the machine, the system comprising:
a support member that includes a plurality of supports that engage the cone circumferentially to the collet system;
a tension member that includes a drawing portion that is engaged by the drawing component to draw down the collet system with a draw down tension; and
a collet body that includes a collet rim that forms a work-piece opening, the surfaces of the collet rim that form the work-piece opening compressively retaining the work-piece with a substantially fixed compression independent of the draw down tension.

7. The system of claim 6, wherein the collet system is a dead length system.

8. The system of claim 6, wherein the tension member further includes retaining surface that imparts a retaining force associated with the draw down tension.

9. The system of claim 8, wherein the support member further includes a support member retaining surface that receives a support member retaining force, the support retaining force engaging the support member with the cone.

10. The system of claim 9, further comprising a support member retaining force component that receives at least part of the retaining force from the tension member and provides the support retaining force to the support member.

11. The system of claim 8, wherein the collet body further includes a collet body retaining surface that receives a collet body retaining force.

12. The system of claim 11, further comprising a collet body retaining force component that receives at least part of the retaining force from the tension member and provides the collet body retaining force to the collet body.

13. The system of claim 6, wherein the surfaces of the collet rim that compressively retain the work-piece are textured to increase friction between the work-piece and the surfaces of the collet rim.

14. The system of claim 13, wherein the surfaces of the collet rim that compressively retain the work-piece are textured with one or more carbide impregnations.

15. The system of claim 6, wherein the profiles of the surfaces of the supports that engage the cone in a lengthwise direction with respect to the collet system are curved.
